(19) United States
(12) Patent Application Publication
(10) Pub. No.: US 2023/0349783 A1
(43) Pub. Date: Nov. 2, 2023

(54) FORCE SENSOR MODULE

(71) Applicant: SINTOKOGIO, LTD., Nagoya-shi (JP)

(72) Inventors: Yoshikane Tanaami, Nagoya-shi (JP); Miyuki Hayashi, Nagoya-shi (JP); Takahiro Kokawaji, Nagoya-shi (JP)

(73) Assignee: SINTOKOGIO, LTD., Nagoya-shi (JP)

(21) Appl. No.: 18/305,588

(22) Filed: Apr. 24, 2023

(30) Foreign Application Priority Data
Apr. 28, 2022 (JP) 2022-075260

(51) Int. Cl. G01L 5/00; B25J 15/10; B25J 19/02

(52) U.S. Cl. CPC G01L 5/009; B25J 15/10; B25J 19/02

(57) ABSTRACT

Provided is a force sensor module which is configured to be disposed between a claw part of a robot hand and a drive section configured to drive the claw part and which includes: a force sensor; a first connection part configured to directly or indirectly connect the force sensor and the drive section; and a second connection part configured to directly or indirectly connect the force sensor and the claw part, the first connection part being connected with a fixing part of the force sensor, the second connection part being connected with a force receiver of the force sensor.

This Nonprovisional application claims priority under 35 U.S.C. § 119 on Patent Application No. 2022-075260 filed in Japan on Apr. 28, 2022, the entire contents of which are hereby incorporated by reference.

### TECHNICAL FIELD

The present invention relates to a force sensor module.

### BACKGROUND ART

Patent Literature 1 below discloses a robot hand which is configured to open and close tip portions of two claws to with use of a linear actuator accommodated in a housing. Two linear shafts driven by the linear actuator are guided to outside of the housing through guiding holes formed in a side surface of the housing. The claws have respective base portions fixed to the linear shaft outside the housing, and a seal member is interposed between the guide hole of the housing and the linear shaft.

Areas in which the base portions of the two claws are each fixed to a corresponding one of the two linear shafts are positioned such that the tip portions of the two claws are disposed between the areas. In addition, at least one of the guide holes is located lower than the tip portions of the claws. Therefore, since the area in which the base portions of the two claws are each fixed to the corresponding one of the two linear shafts are positioned such that the tip portions of the two claws are disposed between the areas, the tip portions can easily hold even a workpiece smaller in size than a side dimension of the housing.

### CITATION LIST

### Patent Literature

[Patent Literature 1]
Japanese Patent Application Publication Tokukai No. 2021-175591

### SUMMARY OF INVENTION

### Technical Problem

Such a robot hand can easily hold a small workpiece with use of the tip portions of the two claws, but cannot detect a holding force at which the workpiece is held. The robot hand may thus damage the workpiece depending on a level of the holding force. Each of the tip portions of the two claws can be equipped with a force sensor to detect the holding force. However, in that case, the size of the claw is dependent on the size of the force sensor, resulting in difficulty in freely changing the size of the claw, for example, making the claw thin. Further, if the sensor is at a distance from an object to be held, moments corresponding to the distance may be generated during operation of the robot. This may damage the force sensor. Thus, it is required to prepare a large force sensor in consideration of the moments. This increases the costs and the weight of the force sensor.

An aspect of the present invention is attained in light of the foregoing problem, and it is an object of an aspect of the present invention to achieve a force sensor module for a robot hand such that the force sensor module can be disposed near the claw part and is attachable to various types of claw parts as necessary.

### Solution to Problem

In order to solve the foregoing problem, the force sensor module in accordance with an aspect of the present invention is a force sensor module which is configured to be disposed between a claw part of a robot hand and a drive section configured to drive the claw part. The force sensor module includes a force sensor, a first connection part, and a second connection part. The first connection part is configured to directly or indirectly connect the force sensor and the drive section. The second connection part is configured to directly or indirectly connect the force sensor and the claw part. The first connection part is connected with a fixing part of the force sensor, and the second connection part is connected with a force receiver of the force sensor.

### Advantageous Effects of Invention

An embodiment of the present invention makes it possible to achieve a force sensor module for a robot hand such that the force sensor module can be disposed near a claw part and is attachable to various claw parts as necessary.

### BRIEF DESCRIPTION OF DRAWINGS

FIG. 1 is an overall perspective view illustrating a robot hand including a force sensor module in accordance with an embodiment of the present invention.

FIG. 2 is a vertical cross-sectional view in a direction of a Z axis illustrating a holding member indicated by a circle A in FIG. 1.

FIG. 3 is an enlarged cross-sectional view illustrating the force sensor module illustrated in FIG. 2.

FIG. 4 is a cross-sectional view illustrating an example of an engagement section included in a force sensor module.

FIG. 5 is a view schematically illustrating an example of a method of connecting a force sensor module and a chuck.

### DESCRIPTION OF EMBODIMENTS

The following will describe an embodiment of the present invention in detail with reference to the drawings. The same or similar constituent elements, members, and processes depicted in the drawings are given the same reference numerals, and the same descriptions are omitted as appropriate.

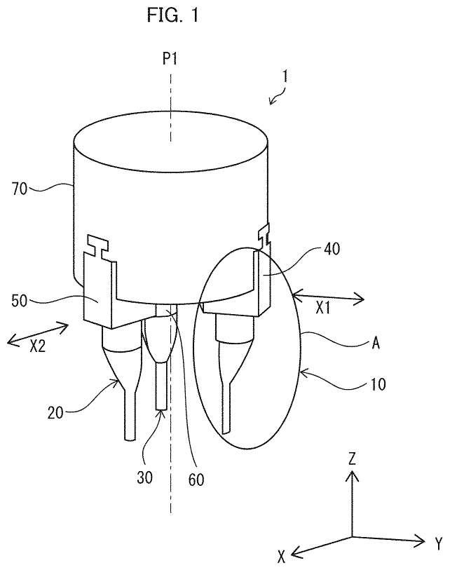

The following will describe an embodiment of the present invention in detail with reference to the drawings. FIG. 1 is an overall perspective view illustrating an example of a configuration of a robot hand 1 including a force sensor module in accordance with an embodiment of the present invention. FIG. 1 shows an X axis direction, a Y axis direction, and a Z axis direction which are orthogonal to each other. The X axis direction and the Y axis direction are two directions orthogonal to each other and form a plane normal to the Z axis direction. The Z axis direction is a direction parallel to a central axis P1 of the robot hand 1. The direction from a tip side to a base end portion side in the robot hand 1 is assumed to be a Z axis positive direction. In addition, the Z axis positive direction may be referred to as “upward direction”, and the Z axis negative direction may be referred to as “downward direction”.

The robot hand 1 is a member to be mounted to a tip portion of a working robot arm and has a function of holding a member to be held (object). As illustrated in FIG. 1, the robot hand 1 includes holding members 10, 20, and 30 each having a claw part for holding the object. The holding members 10, 20, and 30 each have a force sensor module as described later. The holding members 10, 20, and 30 are connected with drive sections 40, 50, and 60, respectively. The holding members 10, 20, and 30 hold the object by synchronously moving inward in a radial direction, and release the object by synchronously moving outward in a radial direction. Note that, in the present embodiment, the three holding members 10, 20, and 30 are provided, but the number of holding members is not limited and may be two or may be four or more. Further, in a case where a working member such as a gripping part or receiving part is mounted to the holding member itself, the number of the holding member may be one.

The drive sections 40, 50, and 60 are members which drive the holding members 10, 20, and 30, respectively. That is, the drive sections 40, 50, and 60 each drive a claw part (described later). The drive sections 40, 50, and 60 are supported by a support member 70. The support member 70 has a substantially cylindrical shape and supports the drive sections 40, 50, and 60 such that the drive sections 40, 50, and 60 are movable in a radial direction. That is, the drive section 40 is movable in a direction indicated by X1, and the drive section 50 is movable in a direction indicated by X2. The drive sections 40, 50, and 60 are disposed at intervals of approximately 120°. The drive sections 40, 50, and 60 may be driven by respective motors included in the drive sections 40, 50, and 60. Alternatively, the drive sections 40, 50, and 60 may be driven by one or more motors contained in the support member 70.

As described above, the holding members 10, 20, and 30 each move in a radial direction of the support member 70, so that the robot hand 1 illustrated in FIG. 1 holds or releases an object. However, the directions in which the holding members 10, 20, and 30 move are not limited to this. For example, the holding members 10, 20, and 30 may turn about the drive sections 40, 50, and 60, respectively to hold or release an object. That is, the drive section may cause a force sensor (described later) and the claw part to integrally turn or translate. Such a configuration allows the force sensor module (described later) to be applicable to both a robot hand having claw parts configured to turn to hold an object and a robot hand having claw parts configured to translate to hold an object.

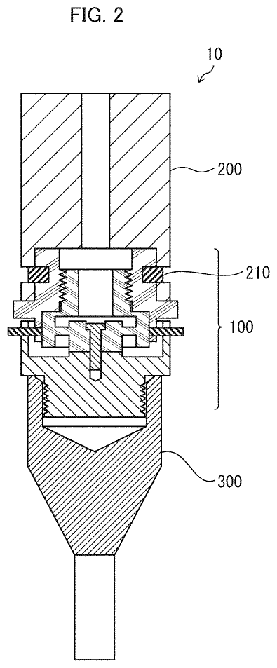

Next, the following will describe the holding members 10, 20, and 30 in detail. The holding members 10, 20, and 30 have a common structure. Thus, the following description takes the holding member 10 as an example, but the same applies to the other holding members 20 and 30. FIG. 2 is a vertical cross-sectional view illustrating the holding member 10 indicated by a circle A in FIG. 1 in the Z axis direction. The holding member 10 includes a force sensor module 100, a chuck 200, and a claw part 300.

The force sensor module in accordance with the present embodiment is disposed between the claw part 300 of the robot hand 1 and the drive section 40 configured to drive the claw part 300. Note that, in the present embodiment, the chuck 200 described later is interposed between the claw part 300 and the drive section 40. The force sensor module 100 includes a force sensor 110 configured to detect a direction and magnitude of a force received by the claw part 300. The claw part 300 is a part for holding an object at a tip portion of the robot hand 1 and allows a lower end portion of the force sensor module 100 to be screwed therein. The claw part 300 is shaped like a column cut in half and is shaped such that a flat part of a cross section of the claw part 300 holds an object. The shape of the claw part 300 is however not limited to the above-described one.

The chuck 200 is a connection member connecting the force sensor module 100 and the drive section 40, and allows an upper end portion of the force sensor module 100 to be screwed therein. A configuration and objective of the chuck 200 will be described later. When the claw part 300 is driven by the drive section 40, the force sensor module 100 can detect the force received by the claw part 300. The force sensor module 100 is disposed near (adjacent to) the claw part 300, so that it is possible to decrease moments received by the force sensor module 100 when the claw part 300 comes into contact with an object or the like.

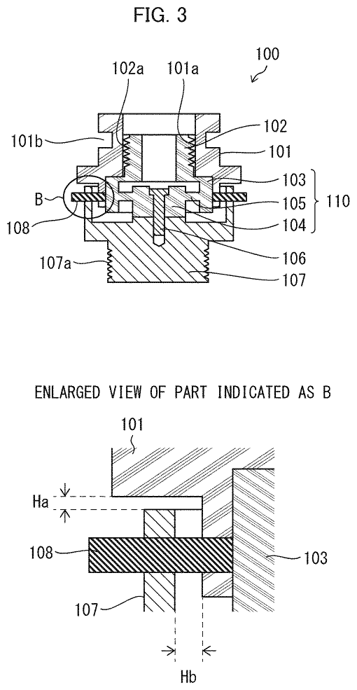

FIG. 3 is an enlarged cross-sectional view illustrating the force sensor module 100 illustrated in FIG. 2. The force sensor module 100 contains, at a center portion thereof, the force sensor 110. Specifically, the force sensor 110 includes a fixing part (frame) 103, a force receiver (core) 104, and an arm part 105. The arm parts 105 are columnar members connecting the fixing part 103 and the force receiver 104, and deform in accordance with the direction and magnitude of the force received by the force receiver 104.

Although the force sensor 110 employed in the present embodiment has the above-described configuration, a type and structure of the force sensor 110 are not limited. Typically, a force sensor is a device which detects a force applied to a force receiver and a torque applied thereto. The force sensor is typically a three-axis force sensor which detects forces in directions of an X axis, a Y axis, and a Z axis or a six-axis force sensor which detects, in addition to the forces, torques about the axes. Alternatively, the force sensor may be the one which detects a part of the forces in directions of the axes and a part of the torques about the axes. Further, a method for detecting the forces and the torques can be a known piezoelectric, strain gauge, optical, or capacitive one or the like, and is not limited.

Although the arm part 105 is provided with a sensor element for detecting the deformation of the arm part 105, the sensor element is not directly related to the present embodiment and thus is omitted in FIG. 3. The force sensor module 100 may further include a standardized input/output terminal unit (not illustrated) including a standardized input terminal to the force sensor 110 and a standardized output terminal from the force sensor 110. The standardized input/output terminal unit is a terminal unit in which input and output terminals that can be shared by different types of force sensor modules are each disposed at a place in common. The terminal unit may be a terminal connector. Including the input/output terminal unit further facilitates replacement of the force sensor module.

A first connection part 101 has a function of directly or indirectly connecting the force sensor 110 and the drive section 40. Specifically, the first connection part 101 has, inside thereof, a hollow having a cylindrical shape and is provided with a screw part 101a at the inner surface of the hollow, as illustrated in FIG. 3. The screw part 101a allows a screw part 102a to be screwed therein. The screw part 102a is provided at an outer periphery of an extended part 102 which protrudes above from the fixing part 103 in the Z axis positive direction. That is, the first connection part 101 is connected with the fixing part 103 of the force sensor 110. The first connection part 101 further includes, at the outer periphery thereof, a groove 101b for allowing the first connection part 101 to be connected with the chuck 200. A method by which the groove 101b is used will be described later.

In the present embodiment, the first connection part 101 is connected with the drive section 40 through the chuck 200, that is, the first connection part 101 is connected indirectly with the drive section 40. In addition, the claw part 300 is connected with the force sensor 110 through a second connection part 107. There are a plurality of types of chucks and a plurality of types of claw parts. Use of the force sensor module including the first connection part 101 and the second connection part 107 makes it possible to freely change a combination of the chuck and the claw part. For example, there are a plurality of chucks 200 that are all configured to be connectable with each of a plurality of types of drive sections 40. When all of the chucks 200 are configured to have a lower end portion connectable with the first connection part 101, one force sensor module 100 can be mounted to any of the drive sections 40. In addition, even in a case where force sensors 110 having different shapes or sizes are used, providing the extended part 102 which is screwed in the screw part 101a of the first connection part 101 enables any of the force sensors 110 to be connected with any of the drive sections 40 through the chuck 200. Alternatively, the connection part of the first connection part 101 and the connection parts of many types of drive sections 40 may be standardized, so that the first connection part 101 and the drive sections 40 are directly connected with each other. In either way, any of the plurality of drive sections 40 can be easily connected with the force sensor module 100.

The second connection part 107 has a function of directly or indirectly connecting the force sensor 110 and the claw part 300. Specifically, a screw part 107a is provided at an outer periphery of a lower portion of the second connection part 107, as illustrated in FIG. 3. The claw part 300 has a cylindrical hollowed part in an upper portion thereof, and an inner surface of the upper portion is provided with a screw part, as illustrated in FIG. 2. In the screw part of the claw part 300, the screw part 107a of the second connection part 107 is screwed, so that the force sensor module 100 and the claw part 300 are connected with each other.

In the present embodiment, the force sensor 110 is directly connected with the claw part 300 by the second connection part 107. This is because increasing proximity of the force sensor 110 and the claw part 300 decreases the moment of the claw part 300 applied to the force sensor 110, resulting in decrease of the load imposed on the force sensor 110. Providing, in all of the plurality of claw parts 300 having different shapes or sizes, a screw part which allows the screw part 107a of the second connection part 107 to be screwed therein enables any of the plurality of claw parts 300 to be connected with the force sensor module 100. Alternatively, for the reason similar to the above-described reason why the chuck 200 is used, the force sensor module 100 and the claw part 300 may be indirectly connected with each other through a connection member (not illustrated) in order to make it possible to select any combination of many types of force sensor modules and many types of claw parts. In either way, any of the plurality of claw parts 300 can be easily connected with the force sensor module 100.

In order to accommodate the force sensor 110, the second connection part 107 has a cylindrical hollowed part in an upper portion thereof, and the hollowed part has a bottom surface at which a screw hole is provided. The force receiver 104 of the force sensor 110 has a through hole provided at the center thereof. The force receiver 104 and the second connection part 107 are fixed to each other by insertion of a bolt 106 into the through hole of the force receiver 104 and screwing of the bolt 106 in the screw hole of the second connection part 107. That is, the second connection part 107 is fixed to the force receiver 104 of the force sensor 110.

As illustrated in an enlarged view of a part indicated as B in FIG. 3, a gap Ha in the Z axis direction and a gap Hb in the radial direction are provided between the fixing part 103 and the second connection part 107. These gaps are provided to allow the arm part 105 to deform in a case where the force receiver 104 receives a force. These gaps Ha and Hb can be designed as appropriate to have sizes that allow the arm part 105 to deform within a limit of the deformation.

That is, setting the sizes of the gaps Ha and Hb appropriately makes it possible to prevent the arm part 105 from deforming beyond the limit of the deformation. In other words, a combination of the fixing part 103 and the second connection part 107 in which the gap Ha and/or Hb has been set to a predetermined size can serve as a deformation reducing part for the force receiver 104 of the force sensor 110. Note that a warning setting may be made to, for example, raise an alarm in a case where the force sensor 110 detects an excessive load, or an emergency stop setting may be made to stop the operation of the robot hand in a case where the force sensor 110 detects an excessive load.

In the above-described embodiment, the first connection part 101 is connected with the fixing part 103 of the force sensor 110, and the second connection part 107 is connected with the force receiver 104 of the force sensor 110. Note that, in the present embodiment, the terms “fixing part 103” and “force receiver 104” do not mean shapes but mean functional relationships which indicate that the fixing part is a member that supports the force receiver, and the force receiver is a member that receives a force from the claw part 300 and cause the arm part to deform. In the present embodiment, the shapes of the fixing part 103 and the force receiver 104 in the force sensor 110 and a connection structure between the fixing part 103 and the force receiver 104 are not limited. That is, the shapes of the fixing part 103 and the force receiver 104 and the connection structure between the fixing part 103 and the force receiver 104 may differ depending on, for example, the type and size of the force sensor 110.

The above-described embodiment is described by taking, as an example, the case where the first connection part 101, the force sensor 110, and the second connection part 107 are positioned in this order in a linear manner. This makes it possible to provide a force sensor module 100 which has a simple structure and is easily replaced. That is, with a simple configuration, the force sensor module 100 is applicable to various drive sections or various claw parts. However, the first connection part 101, the force sensor 110, and the second connection part 107 are not necessarily positioned in a linear manner. For example, depending on a use environment and intended use of the drive section or the holding member, part of the first connection part 101, the force sensor 110, and the second connection part 107 may be positioned off the axis. Further, the first connection part 101, the force sensor 110, and the second connection part 107 may be positioned in a zigzag manner rather than the linear manner.

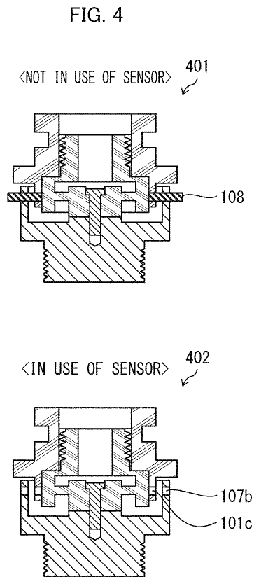

FIG. 4 is a cross-sectional view illustrating an example of an engagement section included in a force sensor module 100. The engagement section has a function of protecting the force sensor 110 by engaging the first connection part 101 and the second connection part 107. Specifically, the force sensor module 100 has, as an engagement section, one or more engagement holes 101c passing through the first connection part 101 and one or more engagement holes 107b passing through the second connection part 107. With such an engagement section, it is possible to prevent an excessive stress from being applied to the force sensor module 100. The engagement hole 101c and the engagement hole 107b are positioned so as to face to each other. This allows insertion of a knock pin 108 into these two engagement holes 101c and 107b. The insertion of the knock pin 108 into the two engagement holes 101c and 107b enables restriction of relative movement of the first connection part 101 and the second connection part 107.

For example, in a case where the force sensor 110 does not need to be operated, such as during the teaching of the robot hand 1 including the force sensor module 100, the knock pin 108 may be inserted into the two engagement holes 101c and 107b, as illustrated in reference number 401 of FIG. 4. The knock pin 108 restricts the relative movement of the first connection part 101 and the second connection part 107, so that much force is not transmitted to the force sensor 110. Thus, even if an unexpected collision occurs during work, the force sensor 110 does not receive an excessive stress. Thus, it is possible to prevent the force sensor 110 from being damaged. In a case where the force sensor 110 needs to be operated, the knock pin 108 is removed as illustrated in reference number 402 of FIG. 4, so that the force sensor 110 is operated as normal.

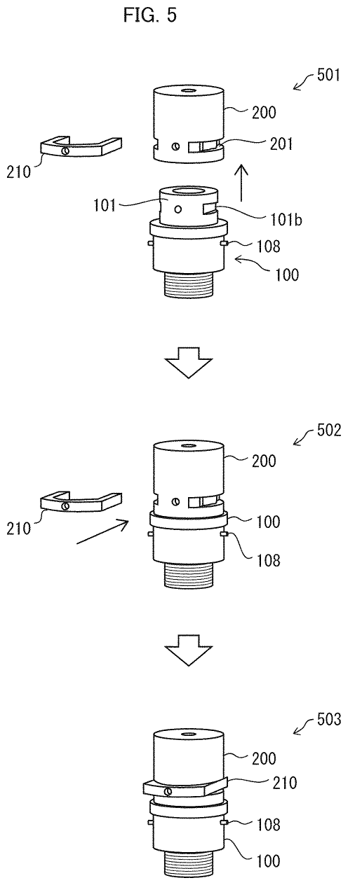

FIG. 5 is a view illustrating an example of a method of connecting the force sensor module 100 and the chuck 200. In the present embodiment, the groove 101b is provided on a side surface of the first connection part 101. The groove 101b and an opening 201 which is provided in the chuck 200 to be connected with the first connection part 101 are fixed to each other by a lock bar. Specifically, first, the first connection part 101 of the force sensor module 100 is inserted into a lower portion of the chuck 200 as illustrated in reference number 501 of FIG. 5. The chuck 200 has the opening 201 provided in the lower portion thereof at a position corresponding to the groove 101b of the first connection part 101. At that time, the knock pin 108 is preferably attached. Subsequently, a lock bar 210 is inserted through the opening 201 into the groove 101b as illustrated in reference number 502 of FIG. 5. This causes the lock bar 210 to be engaged in the groove 101b to connect the force sensor module 100 and the chuck 200, as illustrated in reference number 503 of FIG. 5. Note that the chuck 200 and the support member 70 can be connected with each other by any method. Note, however, that a connection structure between the plurality of chucks and the plurality of support members is preferably standardized between the plurality of chucks and the plurality of support members.

The force sensor module 100 having such a configuration makes it possible to achieve a force sensor module for a robot hand such that the force sensor module can be positioned near a claw part and is attachable to various claw parts as necessary. In addition, the force sensor module is easily replaced in the event of trouble or damage. Mounting a holding member into which this force sensor module is incorporated eliminates the need for disposing a dedicated force sensor at a tip of a robot arm. In addition, this facilitates selecting and assembling a holding member for a robot hand according to need. Further, in a case where a plurality of holding members are included, a plurality of force sensor modules are also included. This increases the number of pieces of force information to be acquired. This makes it possible to accurately detect, for example, a holding force, a weight and a center of gravity of a held object, and forces and moments for engagement, phase focusing and the like. In addition, as compared to the use of a single force sensor, the use of, for example, three force sensors makes it possible to divide a force into three equal portions. This enables a reduction of a minimum weight to be detected to one third without the need to change a resolution of the force sensor.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1 Robot hand
10, 20, 30 Holding member
40, 50, 60 Drive section
70 Support member
100 Force sensor module
101 First connection part
101a, 107a, 102a Screw part
101b Groove
101c, 107b Engagement hole
102 Extended part
103 Fixing part (frame)
104 Force receiver (core)
105 Arm part
106 Bolt
107 Second connection part
108 Knock pin
110 Force sensor
200 Chuck
201 Opening
210 Lock bar
300 Claw part

1. A force sensor module comprising: a force sensor;
a first connection part configured to directly or indirectly connect the force sensor and a drive section configured to drive a claw part of a robot hand; and
a second connection part configured to directly or indirectly connect the force sensor and the claw part,
the force sensor module being configured to be disposed between the claw part and the drive section,
the first connection part being connected with a fixing part of the force sensor,
the second connection part being connected with a force receiver of the force sensor.

2. The force sensor module according to claim 1, wherein the drive section causes the force sensor and the claw part to integrally turn or translate.

3. The force sensor module according to claim 1, wherein the first connection part, the force sensor, and the second connection part are positioned in this order in a linear manner.

4. The force sensor module according to claim 1, further comprising an engagement section engaging the first connection part and the second connection part.

5. The force sensor module according to claim 1, further comprising a standardized input/output terminal unit including a standardized input terminal to the force sensor and a standardized output terminal from the force sensor.

6. The force sensor module according to claim 1, wherein the first connection part has a groove provided on a side surface thereof, and the groove and an opening which is provided in a chuck to be connected with the first connection part are fixed to each other by a lock bar.
